(19) United States
(12) Patent Application Publication
(10) Pub. No.: US 2023/0298548 A1
(43) Pub. Date: Sep. 21, 2023

(54) MUSICAL ELEMENT GENERATION SUPPORT DEVICE, MUSICAL ELEMENT LEARNING DEVICE, MUSICAL ELEMENT GENERATION SUPPORT METHOD, MUSICAL ELEMENT LEARNING METHOD, NON-TRANSITORY COMPUTER-READABLE MEDIUM STORING MUSICAL ELEMENT GENERATION SUPPORT PROGRAM, AND NON-TRANSITORY COMPUTER-READABLE MEDIUM STORING MUSICAL ELEMENT LEARNING PROGRAM

(71) Applicant: Yamaha Corporation, Hamamatsu (JP)

(72) Inventor: Dan SASAI, Hamamatsu (JP)

(21) Appl. No.: 18/322,967

(22) Filed: May 24, 2023

Related U.S. Application Data
(63) Continuation of application No. PCT/JP2021/042636, filed on Nov. 19, 2020.

(30) Foreign Application Priority Data
Nov. 25, 2020 (JP) 2020-194991

(51) Int. Cl. G10H 1/00

(52) U.S. Cl. CPC G10H 1/0025

(57) ABSTRACT

A musical element generation support device includes at least one processor configured to receive a musical element sequence including a plurality of musical elements and a blank portion that are arranged in a time series, and generate, by using a learning model, at least one suitable musical element for the blank portion based on a part of the musical elements that is positioned after the blank portion on a time axis in the musical element sequence. The learning model is configured to generate, from one-part musical element, another-part musical element.

### CROSS-REFERENCE TO RELATED APPLICATIONS

This application is a continuation application of International Application No. PCT/JP2021/042636, filed on Nov. 19, 2021, which claims priority to Japanese Patent Application No. 2020-194991 filed in Japan on Nov. 25, 2020. The entire disclosures of International Application No. PCT/JP2021/042636 and Japanese Patent Application No. 2020-194991 are hereby incorporated herein by reference.

### BACKGROUND

### Technological Field

This disclosure relates to a musical element generation support device that supports the generation of musical elements, a musical element learning device, a musical element generation support method, a musical element learning method, a non-transitory computer-readable medium storing a musical element generation support program, and a non-transitory computer-readable medium storing a musical element learning program.

### Background Information

Automatic composition devices that automatically create melodies are known in the prior art. For example, in the automatic composition device disclosed in Japanese Laid-Open Patent Publication No. 2002-32078, motif melodies are set at a plurality of positions in a musical piece to be generated. By developing each of the set motif melodies in accordance with a template prepared in advance, the melody of a musical piece can be generated.

In the program disclosed in Japanese Laid-Open Patent Publication No. 2020-3535, the type of a prescribed phrase of a musical piece is determined based on a first learned model. In addition, based on a second learned model, a part of one type is created from the determined type of phrase. Further, parts of other types of are sequentially created from the part of one type, using a third learned model. The created plurality of parts are arranged in the order specified by a prescribed template in order to create a musical piece.

### SUMMARY

As described above, in Japanese Laid-Open Patent Publication No. 2002-32078 and Japanese Laid-Open Patent Publication No. 2020-3535, musical pieces are created in accordance with prescribed templates. However, with such a method, it is difficult to adequately reflect the composer’s intentions in the musical piece due to the lack of diversity in the musical pieces that are created.

An object of this disclosure is to provide a musical element generation support device, a musical element learning device, a musical element generation support method, a musical element learning method, a musical element generation support program, and a musical element learning program that can easily generate musical elements that reflect the intentions of the user.

A musical element generation support device according to one aspect of this disclosure comprises at least one processor configured to receive a musical element sequence including a plurality of musical elements and a blank portion that are arranged in a time series, and generate, by using a learning model, at least one suitable musical element for the blank portion based on a part of the musical elements that is positioned after the blank portion on a time axis in the musical element sequence. The learning model is configured to generate, from one-part musical element, another-part musical element.

A musical element generation support method according to yet another aspect of this disclosure comprises receiving a musical element sequence including a plurality of musical elements and a blank portion that are arranged in a time series, and generating at least one musical element for the blank portion based on a part of the musical elements that is positioned after the blank portion on a time axis in the musical element sequence, by using a learning model configured to generate, from one-part musical element, another-part musical element.

A musical element learning method according to yet another aspect of this disclosure comprises acquiring a plurality of musical element sequences each of which includes a plurality of musical elements arranged in a time series, randomly setting a blank portion in a part of each of the musical element sequences, and constructing a learning model indicating a relationship between at least one musical element and a musical element for a blank portion, by machine learning a relationship between at least one of the musical elements for the blank portion and at least one of the musical elements for a portion other than the blank portion in each of the musical element sequences.

### BRIEF DESCRIPTION OF THE DRAWINGS

FIG. 1 is a block diagram showing a configuration of a musical element generation support system that includes a support device according to one embodiment of this disclosure.

FIG. 2 is a block diagram showing a configuration of the support device.

FIG. 3 is a diagram for explaining an operation of the support device.

FIG. 4 is a diagram for explaining the operation of the support device.

FIG. 5 is a diagram for explaining the operation of the support device.

FIG. 6 is a block diagram showing a configuration of a musical element learning system including a learning device according to one embodiment of this disclosure.

FIG. 7 is a block diagram showing a configuration of the learning device.

FIG. 8 is a diagram for explaining an operation of the learning device.

FIG. 9 is a diagram for explaining the operation of the learning device.

FIG. 10 is a flowchart showing one example of a support process by the support device of FIG. 2.

FIG. 11 is a flowchart showing one example of a learning process by the learning device of FIG. 7.

### DETAILED DESCRIPTION OF THE EMBODIMENTS

Selected embodiments will now be explained with reference to the drawings. It will be apparent to those skilled in the field from this disclosure that the following descriptions of the embodiments are provided for illustration only and not for the purpose of limiting the invention as defined by the appended claims and their equivalents.

A musical element generation support device, a musical element learning device, a musical element generation support method, a musical element learning method, a musical element generation support program, and a musical element learning program according to an embodiment of this disclosure will be described in detail below with reference to the drawings. Hereinbelow, the musical element generation support device, the musical element generation support method and musical element generation support program will be respectively referred to as the support device, support method, and support program. Further, the musical element learning device, musical element learning method, and musical element learning program will be respectively referred to as the learning device, learning method, and learning program.

### Configuration of Musical Element Generation Support System

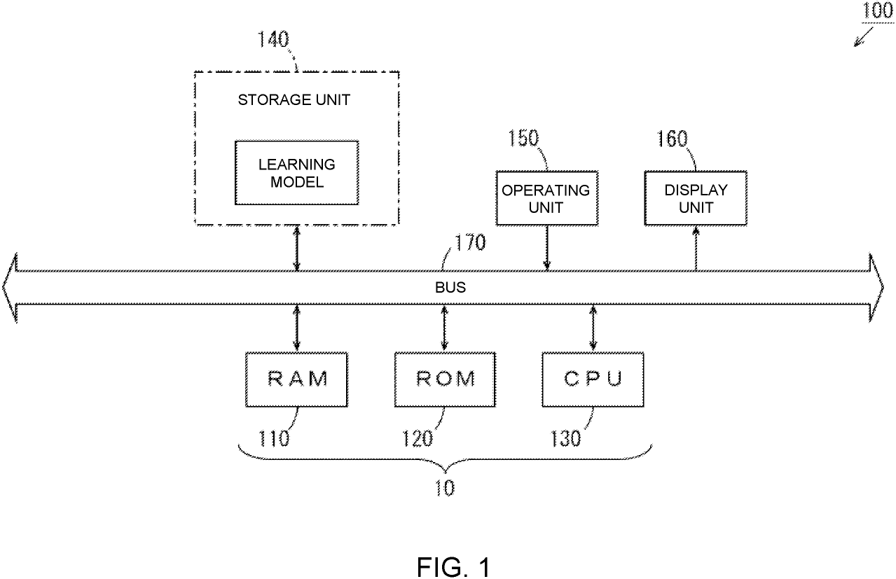

FIG. 1 is a block diagram showing a configuration of a musical element generation support system that includes a support device according to one embodiment of this disclosure. As shown in FIG. 1, a musical element generation support system 100 (hereinafter referred to as support system 100) includes a RAM (random-access memory) 110, a ROM (read- only memory) 120, a CPU (central processing unit) 130, a storage unit 140, an operating unit 150, and a display unit 160.

The support system 100 can be realized by an information processing device such as a personal computer, for example, or by an electronic instrument equipped with a performance function. The RAM 110, the ROM 120, the CPU 130, the storage unit 140, the operating unit 150, and the display unit 160 are connected to a bus 170. The RAM 110, the ROM 120, and the CPU 130 constitute a support device 10.

The RAM 110 is a volatile memory, for example, and is used as work area for the CPU 130, temporarily storing various data. The ROM 120 is a non-volatile memory, for example, and stores a support program. The CPU 130 is one example of at least one processor as an electronic controller of the support device 10, and the CPU 130 executes a support program stored in the ROM 120 on the RAM 110 to carry out a musical element generation support process (hereinafter referred to as support process.). Here, the term “electronic controller” as used herein refers to hardware, and does not include a human. The support system 100 can include, instead of the CPU 130 or in addition to the CPU 130, one or more types of processors, such as a GPU (Graphics Processing Unit), a DSP (Digital Signal Processor), an FPGA (Field Programmable Gate Array), an ASIC (Application Specific Integrated Circuit), and the like. The details of the support process will be described further below.

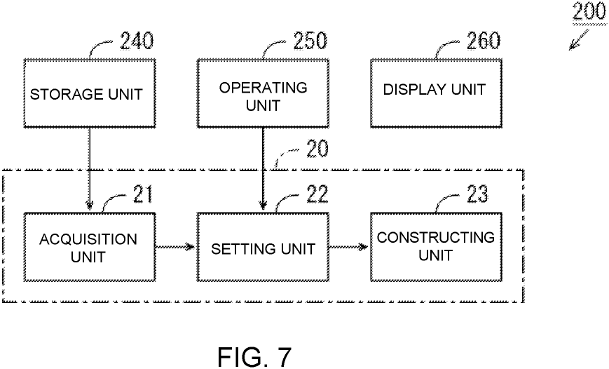

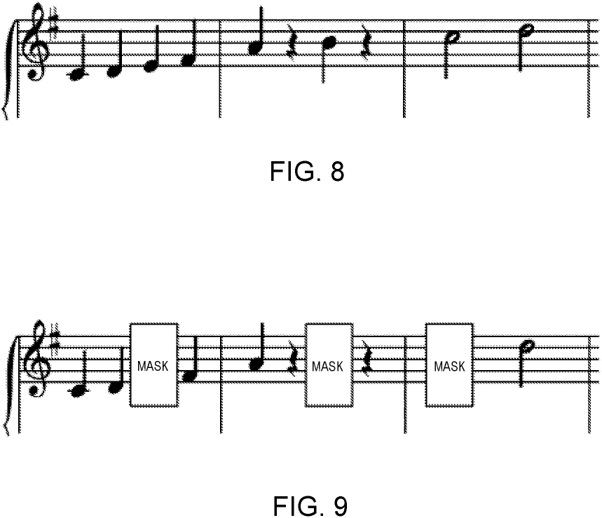

The storage unit (computer memory) 140 includes a storage medium such as a hard disk, an optical disk, a magnetic disk, or a memory card, and stores a learning model constructed in advance by the learning device 20 of FIG. 7, described further below. If the support system 100 is connected to a network such as the Internet, the learning model can be stored in a server on this network instead of the storage unit 140 (including a cloud server). (The same applies to servers mentioned below.)

The learning model indicates the relationship between one portion of musical elements and musical elements in a blank portion, in a sequence of musical elements (musical element sequence) that include a plurality of musical elements arranged in a time series and that include one or more blank portions of the musical elements. Here, a sequence of musical elements includes melody, chord progression, lyrics, or rhythm patterns. If the sequence of musical elements is a melody or a rhythm pattern, the musical elements are musical notes or rests. If the sequence of musical elements is a chord progression, the musical elements are chords. If the sequence of musical elements is lyrics, the musical elements are words.

The storage unit 140, instead of the ROM 120, can store the support program. Alternatively, the support program can be provided in a form stored on a computer-readable storage medium and installed in the ROM 120 or the storage unit 140. A computer memory such as a ROM 120 and/or a storage unit 140 is one example of a non-transitory computer-readable medium. Further, if the support system 100 is connected to a network, a support program distributed from a server on the network can be installed in the ROM 120 or the storage unit 140.

The operating unit (user operable input) 150 includes a keyboard or a pointing device such as a mouse and is operated by a user in order to make prescribed selections or designations. The display unit (display) 160 includes a liquid-crystal display, for example, and displays the results of the support process. The operating unit 150 and the display unit 160 can be formed of a touch panel display.

### Support Device

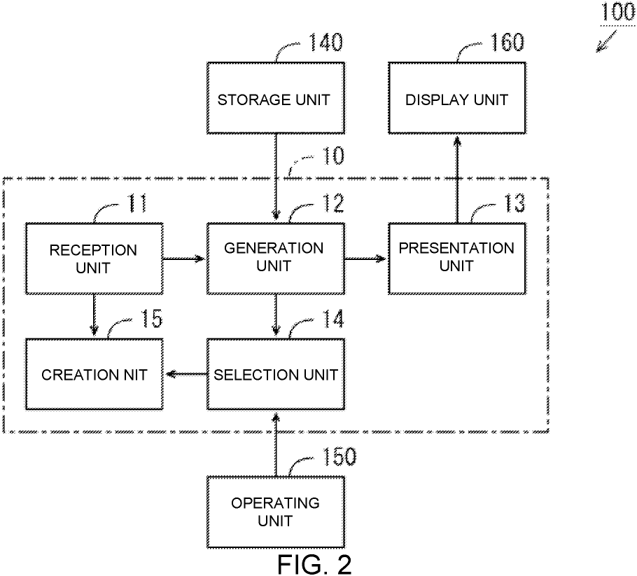

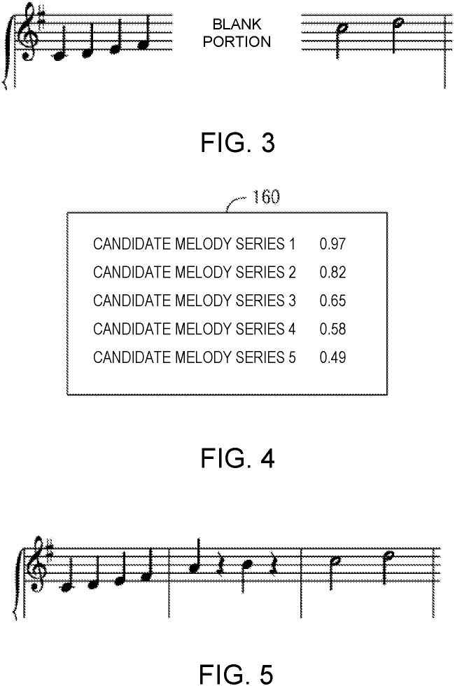

FIG. 2 is a block diagram showing a configuration of the support device 10. FIGS. 3-5 are diagrams for explaining operations of the support device 10. In FIGS. 3-5, the sequence of musical elements is a melody. Thus, the musical elements include the pitch of a musical note and the duration of a musical note or a rest.

As shown in FIG. 2, the support device 10 includes a receiving unit 11, a generation unit 12, a presentation unit 13, a selection unit 14, and a creation unit 15. The functions of the receiving unit 11, the generation unit 12, the presentation unit 13, the selection unit 14, and the creation unit 15 are realized(executed) by the CPU 130 of FIG. 1 executing the support program. At least part of the receiving unit 11, the generation unit 12, the presentation unit 13, the selection unit 14, and the creation unit 15 can be realized in hardware such as electronic circuitry.

The receiving unit 11 receives a sequence of musical elements (musical element sequence) that includes a plurality of musical elements and blank portions that are arranged in a time series. In the sequence of musical elements, there can be one or a plurality of blank portions. In addition, there can be one or a plurality of musical elements in the blank portion.

As shown in FIG. 3, the user can input musical element sequence data that represent the sequence of musical elements being produced to the receiving unit 11. The musical element sequence data can be produced using music production software, for example. In the example of FIG. 3, the sequence of musical elements is defined by a combination of pitches of musical notes or rests, and the times at which the notes or rests are located. The sequence of musical elements being produced includes, in parts thereof, a blank portion in which neither musical notes nor rests are defined

The generation unit 12, by using a learning model stored in the storage unit 140 or the like, generates a plurality of musical elements (suitable musical elements) that are suitable the blank portion, based on one or more musical elements positioned after the blank portion on a time axis in the sequence of musical elements received by the receiving unit 11. Further, the generation unit 12 evaluates the suitability of each of the plurality of musical elements generated for the blank portion.

The presentation unit 13 presents a prescribed number of musical elements for the blank portion generated by the generation unit 12 in order of suitability. In the present embodiment, as shown in FIG. 4, five generated musical elements (suitable musical elements) are displayed on the display unit 160 in order of suitability. The prescribed number described above is not limited to five and can be arbitrarily set by the user. Alternatively, the presentation unit 13 can present, from among musical elements generated by the generation unit 12, musical elements having a higher suitability degree than a prescribed suitability degree. The prescribed suitability described above can be arbitrarily set by the user.

The selection unit 14 selects the designated musical elements from among the plurality of musical elements generated by the generation unit 12. The user, while referring to the suitability and the musical elements presented by the presentation unit 13, can operate the operating unit 150 to designate the desired musical elements from among the musical elements generated by the generation unit 12. Alternatively, the selection unit 14 can select, from among the musical elements generated by the generation unit 12, the musical element having the highest suitability degree. In this case, it is not necessary for the support device 10 to include the presentation unit 13.

The creation unit 15 applies the musical elements selected by the selection unit 14 to the blank portion of the sequence of musical elements received by the receiving unit 11 to create a sequence of musical elements that does not include a blank portion, as shown in FIG. 5.

### Configuration of Musical Element Learning System

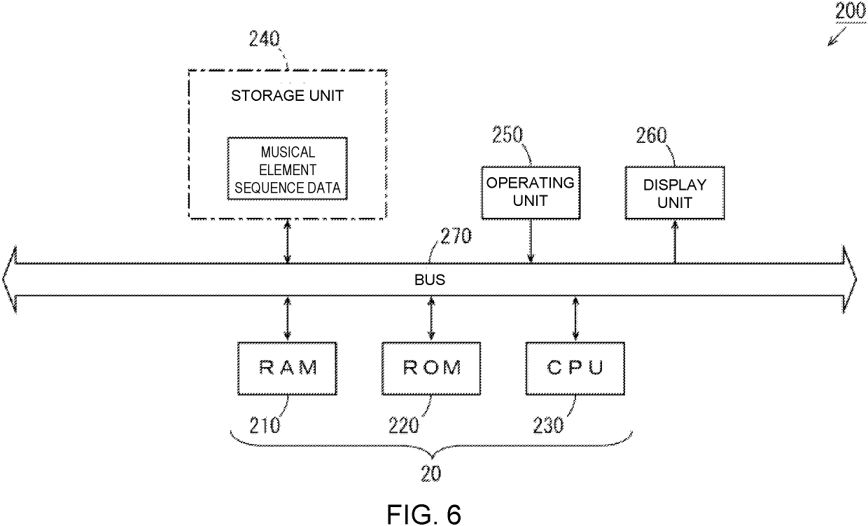

FIG. 6 is a block diagram showing a configuration of a musical element learning system that includes a learning device according to one embodiment of this disclosure. As shown in FIG. 6, a musical element learning system 200 (hereinbelow abbreviated as learning system 200) includes a RAM 210, a ROM 220, a CPU 230, a storage unit 240, an operating unit 250, and a display unit 260.

The learning system 200 can be realized by an information processing device or an electronic instrument, in the same manner as the support system 100 of FIG. 1. Alternatively, the learning system 200 and the support system 100 can be realized by the same hardware resource. The RAM 210, the ROM 220, the CPU 230, the storage unit 240, the operating unit 250, and the display unit 260 are connected to a bus 270. The RAM 210, the ROM 220, and the CPU 230 constitute the learning device 20.

The RAM 210 is a volatile memory, for example, and is used as work area of the CPU 230, temporarily storing various data. The ROM 220 is a non-volatile memory, for example, and stores a learning program. The CPU 230 is one example of at least one processor as an electronic controller of the learning device 20, and the CPU 230 executes a learning program stored in the ROM 220 on the RAM 210 to perform a musical element learning process (hereinafter referred to as learning process.). Here, the term “electronic controller” as used herein refers to hardware, and does not include a human. The learning system 200 can include, instead of the CPU 230 or in addition to the CPU 230, one or more types of processors, such as a GPU (Graphics Processing Unit), a DSP (Digital Signal Processor), an FPGA (Field Programmable Gate Array), an ASIC (Application Specific Integrated Circuit), and the like. Details of the learning process will be mentioned below.

The storage unit 240 includes a storage medium such as a hard disk, an optical disk, a magnetic disk, or a memory card, and stores a plurality of pieces of musical element sequence data. The musical element sequence data can be, for example MIDI (Musical Instrument Digital Interface) data. If the learning system 200 is connected to a network, the musical element sequence data can be stored in a server on the network instead of the storage unit 240.

The storage unit 240, instead of the ROM 220, can store the learning program. Alternatively, the learning program can be provided in a form stored in a computer-readable storage medium and installed in the ROM 220 or the storage unit 240. A computer memory such as a ROM 220 and/or a storage unit 240 is one example of a non-transitory computer-readable medium. In addition, if the learning system 200 is connected to a network, a learning program distributed from a server on the network can be installed in the ROM 220 or the storage unit 240.

The operating unit (user operable input) 250 includes a keyboard or a pointing device such as a mouse and is operated by a user in order to make prescribed selections or designations. The display unit (display) 260 includes a liquid-crystal display, for example, and displays a prescribed GUI (Graphical User Interface) in the learning process. The operating unit 250 and the display unit 260 can be composed of a touch panel display.

### Learning Device

FIG. 7 is a block diagram showing a configuration of the learning device 20. FIGS. 8 and 9 are diagrams for explaining the operation of the learning device 20. In the same manner as FIGS. 3-5, in FIGS. 8 and 9, the musical element sequence is a melody. As shown in FIG. 7, the learning device 20 includes an acquisition unit 21, a setting unit 22, and a construction unit 23. The functions of the acquisition unit 21, the setting unit 22, and the construction unit 23 are realized (executed) by the CPU 230 of FIG. 6 executing a learning program. At least a part of the acquisition unit 21, the setting unit 22, and the construction unit 23 can be realized in hardware such as electronic circuitry.

The acquisition unit 21 acquires the sequence of musical elements indicated by each piece of the musical element sequence data stored in the storage unit 240, and the like. The sequence of musical elements indicated by the musical element sequence data stored in the storage unit 240, and the like, includes a plurality of musical elements arranged in a time series, and does not include a blank portion, as shown in FIG. 8.

As shown in FIG. 9, the setting unit 22 randomly sets a blank portion, as a mask, in a portion of each sequence of musical elements acquired by the acquisition unit 21. The user can use the operating unit 250 and operate the GUI displayed on the display unit 260 to specify the setting conditions of the mask. The mask setting conditions include the number of masks to be set, or the ratio of the length for which the mask is to be set to the length of the sequence of musical elements. The length of each mask on the time axis can be in units of musical notes or units of bars.

The construction unit 23 constructs a learning model indicating a relationship between at least one musical element and a musical element of the masked portion, by machine learning a relationship between the one or more musical elements of the masked portion and at least one of the musical elements for a portion other than the masked portion in each sequence of musical elements acquired by the acquisition unit 21. In the present embodiment, the construction unit 23 executes machine learning using a Transformer, but the embodiment is not limited in this way. The construction unit 23 can carry out machine learning using another method, such as RNN (Recurrent Neural Network), etc.

In the present embodiment, the learning model is constructed to generate musical elements that are suitable for the masked portion based on musical elements positioned after the masked portion on the time axis in each sequence of musical elements. The learning model constructed by the construction unit 23 is stored in the storage unit 140 in FIG. 1. The learning model constructed by the construction unit 23 can be stored in a server on a network.

### Support Process

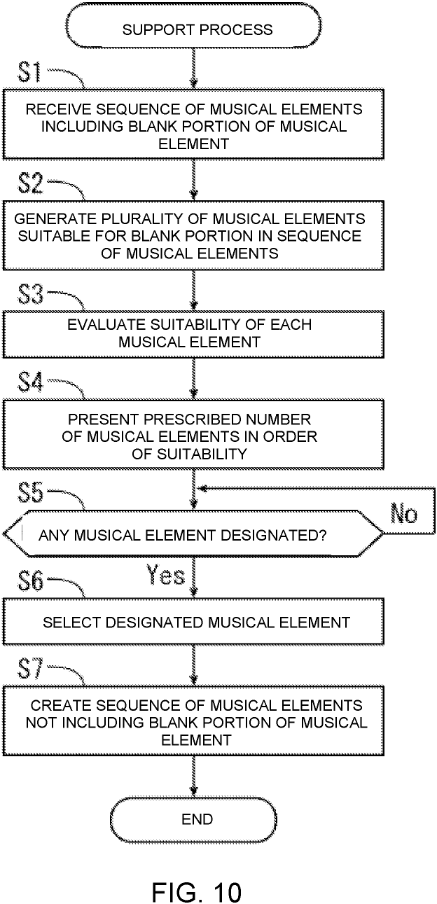

FIG. 10 is a flowchart showing one example of a support process by the support device 10 as a computer as shown in FIG. 2. The support process of FIG. 10 is carried out by the CPU 130 of FIG. 1 executing a support program stored in the ROM 120, the storage unit 140, or the like. First, the receiving unit 11 receives a sequence of musical elements (musical element sequence) including a blank portion of the musical element in a portion thereof (Step S1).

The generation unit 12 then, by using the learning model constructed in Step S15 of the learning process described further below, generates one or a plurality of musical elements (suitable musical elements) that are suitable for the blank portion of the sequence of musical elements received in Step S1 (Step S2). Further, the generation unit 12 evaluates the suitability of each musical element generated in Step S2 (Step S3). The presentation unit 13 then presents a prescribed number of the musical elements generated in Step S2, in order of suitability as evaluated in Step S3 (Step S4).

The selection unit 14 then determines whether any of the plurality of musical elements generated in Step S2 has been designated (Step S5). If a musical element has not been designated, the selection unit 14 stands by until a musical element is designated. If any of the musical elements has been designated, the selection unit 14 selects the designated musical element (Step S6).

Finally, the creation unit 15 applies the musical element selected in Step S6 to the blank portion of the sequence of musical elements received in Step S1 to create a sequence of musical elements that does not include a blank portion of the musical element (Step S7). The support process is thereby completed.

### Learning Process

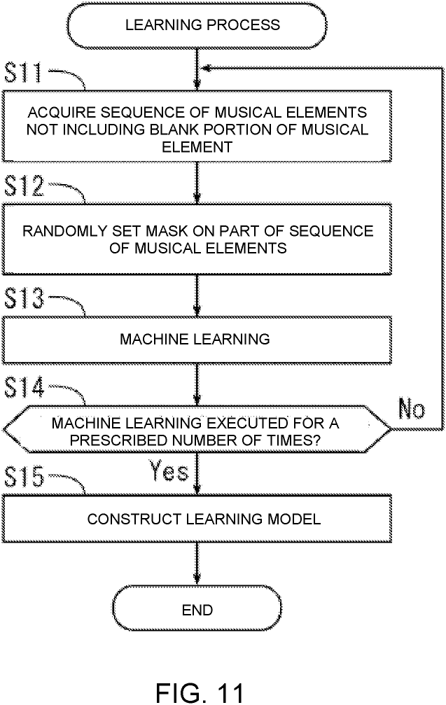

FIG. 11 is a flowchart showing an example of a learning process by the learning device 20 as a computer as shown in FIG. 7. The learning process of FIG. 11 is carried out by the CPU 230 of FIG. 7 executing a learning program stored in the ROM 220, the storage unit 240, or the like. First, the acquisition unit 21 acquires a sequence of musical elements that does not include a blank portion of the musical element (Step S11). The setting unit 22 then randomly sets a mask on a part of the sequence of musical elements acquired in Step S11 (Step S12).

The construction unit 23 then machine-learns the relationship between the musical elements of the masked portion set in Step S12 and the musical elements other than the masked portion in the musical element sequence acquired in Step S11 (Step S13). Thereafter, the construction unit 23 determines whether machine learning has been executed a prescribed number of times (Step S14).

If machine learning has not been executed a prescribed number of times, the construction unit 23 returns to Step S11. Steps S11-S14 are repeated until machine learning has been executed a prescribed number of times. The number of machine learning iterations is set in advance in accordance with the precision of the learning model to be constructed. If machine learning has been executed a prescribed number of times, the construction unit 23 constructs, based on the result of the machine learning, a learning model representing the relationship between the musical elements of a part of the sequence of musical elements and the musical elements of the masked portion (Step S15). The learning process is thereby completed.

### Effects of the Embodiment

As described above, the support device 10 according to the present embodiment comprises the receiving unit 11 for receiving a sequence of musical elements that includes a plurality of musical elements arranged in a time series and that includes blank portions of the musical elements, and the generation unit 12 that uses a learning model that generates, from one part of musical elements (one-part musical element), another part of the musical elements (another part musical element) to generate musical elements of the blank portion based on musical elements positioned after the blank portion on a time axis in the sequence of musical elements.

By this configuration, even if a user cannot conceive of suitable musical elements as part of a process for producing a sequence of musical elements, musical elements that match that portion are generated based on musical elements located after that portion on a time axis. Musical elements that reflect the intentions of the user can thus be easily generated.

The generation unit 12 can generate a plurality of musical elements that are suitable for the blank portion and evaluate the suitability of each of the generated musical elements. In this case, it becomes easier to generate a musical element sequence using musical elements that more naturally match the blank portion.

The support device 10 can further comprise the presentation unit 13 that presents a prescribed number of generated musical elements in order of suitability. In this case, the user can easily recognize musical elements that have a relatively high degree of suitability.

The support device 10 can further comprise the presentation unit 13 that presents, from among the generated musical elements, one or more musical elements that have a higher degree of suitability than a prescribed degree of suitability. In this case, the user can easily recognize musical elements that have a higher degree of suitability than the prescribed degree of suitability.

The support device 10 can further comprise the selection unit 14 that selects, from among the generated musical elements, a musical element having the highest degree of suitability. In this case, musical elements that reflect the intentions of the user can be automatically generated.

The sequence of musical elements can include melody, chord progression, lyrics, or rhythm patterns. In this case, a melody, chord progression, lyrics, or rhythm pattern that reflects the intentions of the user can easily be generated.

The learning device 20 according to the present embodiment comprises the acquisition unit 21 for acquiring a plurality of sequences of musical elements that include a plurality of musical elements arranged in a time series, the setting unit 22 for randomly setting a blank portion in a part of each sequence of musical elements, and the construction unit 23 for constructing a learning model indicating a relationship between one portion of the musical elements and the musical elements of the blank portion by machine learning a relationship between the musical elements of the blank portions and the musical elements of other portions besides the blank portion in each sequence of musical elements. In this case, a learning model that can generate musical elements that reflect the intentions of the user can be constructed.

### Other Embodiments

In the embodiment described above, the learning model is constructed by the construction unit 23 of the learning device 20 to generate musical elements that match the masked portion based on musical elements positioned after the masked portion on the time axis in each sequence of musical elements. Thus, the generation unit 12 of the support device 10 uses the learning model to generate musical elements matching the blank portions based on musical elements positioned after the blank portions on a time axis in the sequence of musical elements.

However, the embodiments are not limited by the foregoing. The learning model can be constructed by the construction unit 23 to generate musical elements that match the masked portion based on musical elements positioned before and after the masked portion on the time axis in each sequence of musical elements. In this case, the generation unit 12 can use the learning model to generate musical elements matching the blank portion based on one of more musical elements positioned before the blank portion and one or more musical elements positioned after the blank portion on a time axis in the sequence of musical elements. By this configuration, musical element that match the blank portions can be more naturally generated.

Further, in the embodiment described above, the generation unit 12 generates a plurality of musical elements that are suitable for the blank portion and evaluates the suitability of each of the generated musical elements, but the embodiment is not limited in this way. The generation unit 12 can generate only one musical element that match the blank portion. In this case, it is not necessary for the generation unit 12 to evaluate the suitability of the generated musical elements.

### Effects

By this disclosure, musical elements that reflect the intentions of the user can be easily generated.

### Additional Statement

A musical element learning device according to one aspect of this disclosure comprises at least one processor configured to execute an acquisition unit, a setting unit, and a construction unit. The acquisition unit is configured to acquire a plurality of musical element sequences each of which includes a plurality of musical elements arranged in a time series. The setting unit is configured to randomly set a blank portion in a part of each of the musical element sequences. The construction unit is configured to construct a learning model indicating a relationship between at least one musical element and a musical element for a blank portion, by machine learning a relationship between at least one of the musical elements for the blank portion and at least one of the musical elements for a portion other than the blank portion in each of the musical element sequences.

A non-transitory computer-readable medium storing a musical element generation support program according to another aspect of this disclosure causes a computer to execute a musical element generation support method. The musical element generation support method comprises receiving a musical element sequence including a plurality of musical elements and a blank portion that are arranged in a time series, and generating at least one musical element for the blank portion based on a part of the musical elements that is positioned after the blank portion on a time axis in the musical element sequence, by using a learning model configured to generate, from one-part musical element, another-part musical element.

A non-transitory computer-readable medium storing a musical element learning program according to yet another aspect of this disclosure causes a computer to execute a musical element learning method. The musical element learning method comprises acquiring a plurality of musical element sequences each of which includes a plurality of musical elements arranged in a time series, randomly setting a blank portion in a part of each of the musical element sequences, and constructing a learning model indicating a relationship between at least one musical element and a musical element for a blank portion, by machine learning a relationship between at least one of the musical elements for the blank portion and at least one of the musical elements for a portion other than the blank portion in each of the musical element sequences.

What is claimed is:

1. A musical element generation support device comprising:
at least one processor configured to
receive a musical element sequence including a plurality of musical elements and a blank portion that are arranged in a time series, and
generate, by using a learning model, at least one suitable musical element for the blank portion based on a part of the musical elements that is positioned after the blank portion on a time axis in the musical element sequence, the learning model being configured to generate, from one-part musical element, another-part musical element.

2. The musical element generation support device according to claim 1, wherein
the at least one processor is configured to generate, by using the learning model, the at least one suitable musical element for the blank portion based further on a part of the musical elements that is positioned before the blank portion on the time axis in the musical element sequence.

3. The musical element generation support device according to claim 1, wherein
the at least one processor is configured to generate a plurality of suitable musical elements that are suitable for the blank portion and evaluate suitability of each of the plurality of suitable musical elements.

4. The musical element generation support device according to claim 3, wherein
the at least one processor is further configured to present only a prescribed number of the plurality of suitable musical elements in order of suitability.

5. The musical element generation support device according to claim 3, wherein
the at least one processor is further configured to present, from among the plurality of suitable musical elements, at least one suitable musical element having a higher suitability degree than a prescribed suitability degree.

6. The musical element generation support device according to claim 3, wherein
the at least one processor is further configured to select, from among the plurality of suitable musical elements, a suitable musical element with a highest suitability degree.

7. The musical element generation support device according to claim 1, wherein
the musical element sequence includes melodies, chord progressions, lyrics, or rhythm patterns.

8. A musical element generation support method comprising:
receiving a musical element sequence including a plurality of musical elements and a blank portion that are arranged in a time series; and
generating at least one musical element for the blank portion based on a part of the musical elements that is positioned after the blank portion on a time axis in the musical element sequence, by using a learning model configured to generate, from one-part musical element, another-part musical element.

9. The musical element generation support method according to claim 8, wherein
the generating is performed, by using the learning model, based further on a part of the musical elements that is positioned before the blank portion on the time axis in the musical element sequence.

10. The musical element generation support method according to claim 8, wherein
in the generating, a plurality of suitable musical elements that are suitable for the blank portion are generated, and
the musical element generation support method further comprises evaluating suitability of each of the plurality of suitable musical elements.

11. The musical element generation support method according to claim 10, further comprising
presenting only a prescribed number of the plurality of suitable musical elements in order of suitability.

12. The musical element generation support method according to claim 10, further comprising
presenting, from among the plurality of suitable musical elements, at least one suitable musical element having a higher suitability degree than a prescribed suitability degree.

13. The musical element generation support method according to claim 10, further comprising
selecting, from among the plurality of suitable musical elements, a suitable musical element with a highest suitability degree.

14. The musical element generation support method according to claim 8, wherein
the musical element sequence includes melodies, chord progressions, lyrics, or rhythm patterns.

15. A musical element learning method comprising:
acquiring a plurality of musical element sequences each of which includes a plurality of musical elements arranged in a time series;
randomly setting a blank portion in a part of each of the musical element sequences; and
constructing a learning model indicating a relationship between at least one musical element and a musical element for a blank portion, by machine learning a relationship between at least one of the musical elements for the blank portion and at least one of the musical elements for a portion other than the blank portion in each of the musical element sequences.
